(19) United States
(12) Patent Application Publication
(10) Pub. No.: US 2002/0106185 A1
(43) Pub. Date: Aug. 8, 2002

(54) Recording and reproducing apparatus

(76) Inventors: Chiaki Fujii, Saijo-shi (JP); Hisatoshi Mori, Niihama-shi (JP); Koichi Kameyama, Saijo-shi (JP)

Correspondence Address: RATNER AND PRESTIA, Suite 301, One Westlakes, Berwyn, P.O. Box 980, Valley Forge, PA, 19482-0980, US

(21) Appl. No.: 10/021,536

(22) Filed: Oct. 30, 2001

(30) Foreign Application Priority Data
Oct. 30, 2000 (JP) 2000-331264

(51) Int. Cl. H04N 5/92; G11B 5/00

(52) U.S. Cl. 386/46; 386/83; 360/7

(57) ABSTRACT

A recording and reproducing apparatus for receiving program data including video data and/or voice data and recording and/or reproducing the program data, has

a temporary saving area that is a ring buffer of temporarily recording the program data;

a long-term saving area of recording the program data for a long term; and

record reproducing means of at least performing recording, reproduction or time shift reproduction of the program data in the temporary saving area and/or the long-term saving area,

wherein the record reproducing means copies predetermined program data recorded at least in the temporary saving area to the long-term saving area if the record reproducing means is instructed to record the program data for a long term when it is performing in the temporary saving area the time shift reproduction of program data that is being received.

### BACKGROUND OF THE INVENTION

1. Field of the Invention

The present invention relates to a recording and reproducing apparatus or the like for receiving program data such as videos, voices or the like and then recording and reproducing the program data, which utilizes program data in a temporary storage area to allow a user to record desired program data from an arbitrary position. In addition, the present invention also relates to a recording and reproducing apparatus or the like for, if image qualities of program data vary, allowing a user to convert a high image quality parts to a low image quality to make image qualities uniform.

2. Description of the Related Art

Conventionally, there is a technology disclosed in Japanese Patent Laid-open Hei 7-264529 as a time reproduction apparatus that relates to a television apparatus for receiving a broadcast and outputting images and, in particular, allows a user to view-a certain broadcast at any desired time.

Such a time reproduction apparatus disclosed in a conventional example has a memory device for, upon receiving a broadcast transmitted by electronic waves or wire, sequentially recording the broadcast for a fixed time range. The memory device can separately designate an address for recording the broadcast and an address for reproducing the data, simultaneously recording the broadcast and reproduction of data recorded in an address separate from the address in which the broadcast is being recorded, and perform time shift reproduction for freely selecting an address progressing speed and a direction of reproduction without regard to an address progressing speed for recording the broadcast. In addition, the entire disclosure of said Japan Patent Laid-open Hei7-264529 is incorporated herein by reference in its entirely.

In the following description, FIG. 13 is a block diagram showing a configuration of the time reproduction apparatus. In the drawing, reference numeral 1301 denotes an antenna for receiving a broadcast from the outside, 1302 denotes a tuner, 1303 denotes a monitor, 1304 denotes an image memory, 1305 denotes a voice memory, 1306 denotes a calculating device, 1307 denotes a memory controller, 1308 denotes an alteration switch, 1309a and 1309b denote A/D converters for converting an incoming analog signal to a digital signal and 1310a and 1310b are D/A converters for converting an incoming digital signal to an analog signal.

An operation of time shift reproduction by the time shift reproduction apparatus having such a configuration will be described.

An electronic wave emitted from a broadcast station is inputted in the tuner 1302 through the antenna 1301. The electronic wave inputted in the tuner 1302 is taken out in the middle of a route connected to the monitor 1303 and divided into a video signal and a voice signal to be distributed.

The distributed video signal and voice signal are digitally converted by the A/D converters 1309a and 1309b and sequentially written in the image memory 1304 and the voice memory 1305, respectively.

The memory controller 1306 outputs writing addresses for writing data in the image memory 1304 and the voice memory 1305 continuously at an equal interval and, at the same time, outputs a reading address obtained from the calculating device 1307 and a reading address along a progressing speed and a progressing direction to the image memory 1304 and the voice memory 1305 in accordance with an instruction of special reproduction from a user.

Upon receiving the reading address along the address progressing speed and the progressing direction from the calculating device 1307, the image memory 1304 and the voice memory 1305 read out an image and image data for the special reproduction designated by the user and output them to the monitor 1303. Here, as an example of the special reproduction, a fast forward reproduction is performed by increasing a progressing speed of a reproduction address with respect to a progressing speed of a recording address. In addition, a rewinding reproduction is performed by reversing a progressing direction of the reproduction address with respect to the progressing direction of the recording address. In addition, a pause is performed by fixing the reproduction address.

Switching of an output to the monitor 1303 between an original image outputted from the tuner 1302 and a special reproduction image outputted from the image memory 1304 and the voice memory 1305 is performed by the alteration switch 1308 or image composition such as PinP.

Therefore, the writing address and the reading address of the image memory 1304 and the voice memory 1305 are simultaneously controlled by the memory controller 1306, whereby data can be reproduced at any time.

The operation of the time shift reproduction by the conventional time reproduction apparatus is as described above. However, a memory such as the image memory 1304 and the voice memory 1305 for recording a program that is currently broadcasted, which is used by a user for time shift reproduction of data at any desired time, has a configuration of a ring buffer that is capable of recording data for a fixed time range.

In such a ring buffer, when a recording time of data exceeds a fixed time range, old data that has already been recorded is overwritten with new data and erased.

Thus, if a user wishes to view a program that is being time shift recorded afterwards, the user has to record data that is being received in a memory for long-term recording different from the ring buffer such that the data is not deleted by overwriting through the ring buffer. This memory for long-term recording becomes, for example, a recording area provided on a memory identical with that of the ring buffer.

However, as shown in FIG. 14, when a recording operation of a ring buffer 1400 and the memory for long-term recording 1401 are taken into account, if the time shift reproduction is performed in the time shift reproduction apparatus and a reading address 1402 for recording a broadcast from the tuner 1302 in the ring buffer 1400 and a reading address 1403 for performing data reproduction from the ring buffer 1400 are different, in the case when a record of a program which is currently being time shift reproduced by the user is going to be recorded in the memory 1401 for a long-term recording, a recording position of data to be broadcasted is a position to which a recording position of the writing address 1402 on the ring buffer 1400 directly shifts in the memory 1401 for the long-term recording.

Therefore, data from the reading address 1403 to the writing address 1402 that is viewed by the time shift reproduction remains on the ring buffer 1400 and is not saved in the memory 1401 for long-term recording. Thus, there is an inconvenience in that the user cannot view the data recorded between the addresses even afterwards.

### SUMMARY OF THE INVENTION

The present invention has been achieved in view of these problems, and it is an object of the present invention to provide a recording and reproducing apparatus that is capable of recording a program that is currently viewed from an arbitrary position.

The 1st invention of the present invention is a recording and reproducing apparatus for receiving program data including video data and/or voice data and recording and/or reproducing said program data, comprising:

a temporary saving area that is a ring buffer of temporarily recording said program data;

a long-term saving area of recording said program data for a long term; and

record reproducing means of at least performing recording, reproduction or time shift reproduction of said program data in said temporary saving area and/or said long-term saving area,

wherein said record reproducing means copies predetermined program data recorded at least in said temporary saving area to said long-term saving area if said record reproducing means is instructed to record said program data for a long term when it is performing in said temporary saving area the time shift reproduction of program data that is being received.

The 2nd invention of the present invention is the recording and reproducing apparatus according to 1st invention, wherein said record reproducing means copies program data after temporarily recording said program data in said temporary saving area until the program of said program data that is being received ends.

The 3rd invention of the present invention is a recording and reproducing apparatus for receiving program data including video data and/or voice data and recording and/or reproducing said program data, comprising:

a temporary saving area that is a ring buffer of temporarily recording said program data;

a long-term saving area of recording said program data for a long term; and

record reproducing means of at least performing recording, reproduction or time shift reproduction of said program data in said temporary saving area and/or said long-term saving area,

wherein said record reproducing means copies predetermined program data recorded in said temporary saving area to said long-term saving area and at the same time records program data that is being received other than that copied in said long-term saving area in said long-term saving area if said record reproducing means is instructed to record said program data for a long term when it is performing the time shift reproduction of said program data that is being received in said temporary saving area.

The 4th invention of the present invention is the recording and reproducing apparatus according to 3rd invention,

wherein timing at which said record reproducing means copies said program data from said temporary saving area to said long-term saving area is performed immediately after said record reproducing means is instructed to record said program data for a long time.

The 5th invention of the present invention is the recording and reproducing apparatus according to 3rd invention,

wherein timing at which said record reproducing means copies said program data from said temporary saving area to said long-term saving area is performed immediately before said temporary saving area is overwritten and recorded.

The 6th invention of the present invention is the recording and reproducing apparatus according to 3rd invention,

wherein said record reproducing means records said program data that is being received in said long-term saving area after stopping at least a recording operation with respect to said temporary saving area.

The 7th invention of the present invention is the recording and reproducing apparatus according to 3rd invention,

wherein said predetermined program data to be copied from said temporary saving area to said long-term saving area is all or a part of program data recorded in said temporary saving area and, in case of said part of said recorded program data, said predetermined program data is data recorded in an arbitrary area on said temporary saving area.

The 8th invention of the present invention is a recording and reproducing apparatus for receiving program data including video data and/or voice data and recording and/or reproducing said program data, comprising:

a recording area in which a temporary saving area of temporarily recording said program data and a long-term saving area of recording said program data for a long term can be set; and

record reproducing means for setting said temporary saving area and said long-term saving area on said recording area and performs at least recording, reproduction or time shift reproduction of said program data in said temporary saving area or said long-term saving area,

wherein said record reproducing means resets a predetermined portion in which said program data from a reproduction position address to a recording position address at the time of said time shift reproduction on said temporary saving area as said long-term saving area if said record reproducing means is instructed to record said program data for a long term when it is performing in said temporary saving area the time shift reproduction of program data that is being received.

The 9th invention of the present invention is the recording and reproducing apparatus according to 8th invention,

wherein said predetermined portion to be treated as said long-term saving area, in which said program data is recorded on said temporary saving area, is all or a part of said temporary saving area and, in case of said part of said temporary saving area, said predetermined portion is data recorded in an arbitrary area on said temporary saving area.

The 10th invention of the present invention is the recording and reproducing apparatus according to 8th invention,

wherein an area of a size identical with a long-term saving area obtained by said resetting on said long-term saving area is reset as said temporary saving area.

The 11th invention of the present invention is the recording and reproducing apparatus according to any one of 1st, 3rd and 8h invention,

wherein said program data is temporarily recorded in the order of receipt in said temporary saving area, and

said program data is temporarily recorded such that said program data can be identified from each other for each channel and/or each program on said temporary saving area.

The 12th invention of the present invention is the recording and reproducing apparatus according to 11th invention,

wherein said record reproducing means connects predetermined portions among said program data temporarily recorded in said temporary saving area based on an input from a user and copies the connected portions to said long-term saving area.

The 13th invention of the present invention is the recording and reproducing apparatus according to 11th invention,

wherein said program data with said predetermined portions connected belongs to one program.

The 14th invention of the present invention is the recording and reproducing apparatus according to 11th invention,

wherein identification of said program data is de fined by an EPG (Electronic Program Guide).

The 15th invention of the present invention is the recording and reproducing apparatus according to any one of 1st, 3rd and 8th inventions,

wherein said record reproducing means deletes program data recorded in said temporary saving area if any program of program data temporarily recorded in said temporary saving area ends.

The 16th invention of the present invention is the recording and reproducing apparatus according to 15th invention,

wherein said any program is a program that a user is currently being viewed by a user.

The 17th invention of the present invention is the recording and reproducing apparatus according to 15th invention, further comprising notifying means of notifying a user of operating contents of said recording and reproducing apparatus,

wherein said notifying means notifies the user that program data recorded in said temporary saving area is to be deleted.

The 18th invention of the present invention is the recording and reproducing apparatus according to 15th invention, further comprising an input unit for receiving an input operation from a user,

wherein program data in said temporary saving area is deleted by the input operation of the user via said input unit.

The 19th invention of the present invention is the recording and reproducing apparatus according to 15th invention,

wherein a time when said program ends is defined by an EPG (Electronic Program Guide).

The 20th invention of the present invention is the recording and reproducing apparatus according to any one of 1st, 3rd and 8th inventions,

wherein said temporary saving area has a plurality of temporary saving files.

The 21st invention of the present invention is the recording and reproducing apparatus according to 20th invention,

wherein said program data of one program is temporarily recorded in one of said temporary saving files.

The 22nd invention of the present invention is the recording and reproducing apparatus according to 20th or 21st invention,

wherein said temporary saving file has temporary saving files in a number of programs that a user has viewed.

The 23rd invention of the present invention is the recording and reproducing apparatus according to 21st invention,

wherein said program is defined by an EPG (Electronic Program Guide).

The 24th invention of the present invention is the recording and reproducing apparatus according to any one of 1st, 3rd and 8th inventions, further comprising image quality changing means of changing an image quality of program data to be recorded in said temporary saving area and/or said long-term saving area.

The 25th invention of the present invention is the recording and reproducing apparatus according to 24th invention,

wherein change of an image quality of program data to be recorded in said long-term saving area is for making the image quality equal to or lower than an image quality of program data temporarily recorded in said temporary saving area.

The 26th invention of the present invention is the recording and reproducing apparatus according to 25th invention,

wherein an image quality of said program data to be temporarily recorded in said temporary saving area is set at the highest.

The 27th invention of the present invention is the recording and reproducing apparatus according to 24th invention,

wherein said image quality changing means makes all image qualities of program data of an identical program to coincide with each other if an image quality varies in said program data of said identical program.

The 28th invention of the present invention is the recording and reproducing apparatus according to 27th invention,

wherein an operation for making all the image qualities of said program data of said identical program is automatically performed when said program ends.

The 29th invention of the present invention is the recording and reproducing apparatus according to 27th invention,

wherein an operation for making all the image qualities of said program data of said identical program is automatically performed when said record reproducing means is not performing a recording operation after said program ends.

The 30th invention of the present invention is the recording and reproducing apparatus according to 24th invention,

wherein said record reproducing means records program data for a long term with an image quality identical with that of program data saved in said temporary saving area until a program ends and said image quality changing means converts an image quality of program data recorded in said long-term saving area to an image quality designated by a user after said program ends if an image quality different from an image quality of program data recorded in said temporary saving area is designated in said image quality changing means in recording program data for a long time in said long-term saving area.

The 31st invention of the present invention is the recording and reproducing apparatus according to any one of 28th to 30th inventions,

wherein the end of said program is defined based on an EPG (Electronic Program Guide).

The 32nd invention of the present invention is the recording and reproducing apparatus according to 24th invention, further comprising a scene change detecting unit for detecting a change of scenes in program data of identical programs or programs different from each other,

wherein said image quality changing means has a function for, if a long-term recording of an image quality different from an image quality recorded in said temporary saving area is designated, changing an image quality to an image quality designated by the user based on said change of scenes detected by said scene change detecting unit.

The 33rd invention of the present invention is the recording and reproducing apparatus according to 1st or 8th inventions,

wherein said ring buffer of said temporary saving area has a variable length.

The 34th invention of the present invention is the recording and reproducing apparatus according to 3rd or 8th inventions,

wherein said ring buffer of said temporary saving area has a fixed length.

The 35th invention of the present invention is a recording and reproducing method for receiving program data including video data and/or voice data and recording and/or reproducing said program data, comprising:

a step of using a temporary saving area that is a ring buffer of temporarily recording said program data and a long-term saving area of recording said program data for a long term; and

a record reproducing step of at least performing recording, reproduction or time shift reproduction of said program data in said temporary saving area and/or said long-term saving area,

wherein by said record reproducing step predetermined program data recorded at least in said temporary saving area is copied to said long-term saving area if in said record reproducing step it is instructed to record said program data for a long term when the time shift reproduction of program data that is being received in said temporary saving area is performed.

The 36th invention of the present invention is a recording and reproducing method for receiving program data including video data and/or voice data and recording and/or reproducing said program data, comprising:

a step of using a temporary saving area that is a ring buffer of temporarily recording said program data and a long-term saving area of recording said program data for a long term; and

a record reproducing step of at least performing recording, reproduction or time shift reproduction of said program data in said temporary saving area and/or said long-term saving area,

wherein by record reproducing means predetermined program data recorded in said temporary saving area is copied to said long-term saving area and at the same time program data that is being received other than that copied in said long-term saving area in said long-term saving area is recorded if in said record reproducing means it is instructed to record said program data for a long term when the time shift reproduction of said program data that is being received in said temporary saving area is performed.

The 37th invention of the present invention is a recording and reproducing method for receiving program data including video data and/or voice data and recording and/or reproducing said program data, comprising:

a step of using a recording area in which a temporary saving area of temporarily recording said program data and a long-term saving area for recording said program data of a long term can be set; and

a record reproducing step of setting said temporary saving area and said long-term saving area on said recording area and performs at least recording, reproduction or time shift reproduction of said program data in said temporary saving area or said long-term saving area,

wherein by said record reproducing means a predetermined portion in which said program data from a reproduction position address to a recording position address is reset at the time of said time shift reproduction on said temporary saving area as said long-term saving area if in said record reproducing step it is instructed to record said program data for a long term when the time shift reproduction of program data that is being received in said temporary saving area is performed.

The 38th invention of the present invention is a program for causing a computer to function as all or any of the record reproducing means of at least performing recording, reproduction or time shift reproduction of said program data in said temporary saving area and/or said long-term saving area of the recording and reproducing apparatus according to 1st invention.

The 39th invention of the present invention is a program for causing a computer to function as all or any of the record reproducing means of at least performing recording, reproduction or time shift reproduction of said program data in said temporary saving area and/or said long-term saving area of the recording and reproducing apparatus according to 3rd invention.

The 40th invention of the present invention is a program for causing a computer to function as all or any of the record reproducing means of setting said temporary saving area and said long-term saving area on said recording area and performs at least recording, reproduction or time shift reproduction of said program data in said temporary saving area or said long-term saving area of the recording and reproducing apparatus according to 8th invention.

The 41st invention of the present invention is a medium to store programs for causing a computer to function as all or any of the record reproducing means of at least performing recording, reproduction or time shift reproduction of said program data in said temporary saving area and/or said long-term saving area of the recording and reproducing apparatus according to 1st invention, wherein said medium is enable to be processed by said computer.

The 42nd invention of the present invention is a medium to store programs for causing a computer to function as all or any of the record reproducing means of at least performing recording, reproduction or time shift reproduction of said program data in said temporary saving area and/or said long-term saving area of the recording and reproducing apparatus according to 3rd invention, wherein said medium is enable to be processed by said computer.

The 43rd invention of the present invention is a medium to store programs for causing a computer to function as all or any of the record reproducing means of setting said temporary saving area and said long-term saving area on said recording area and performs at least recording, reproduction or time shift reproduction of said program data in said temporary saving area or said long-term saving area of the recording and reproducing apparatus according to 8th invention, wherein said medium is enable to be processed by said computer.

### BRIEF DESCRIPTION OF THE DRAWINGS

FIG. 1 is a block diagram of a recording and reproducing apparatus according to first, second and third embodiments of the present invention;

FIG. 2 is a block diagram of a recording and reproducing apparatus according to fourth and fifth embodiments of the present invention;

FIG. 3 is a block diagram of a recording and reproducing apparatus according to sixth and eighth embodiments of the present invention;

FIG. 4 is a block diagram of a recording and reproducing apparatus according to a seventh embodiment of the present invention;

FIG. 5 is a map of program data in a recording device 103 in the recording and reproducing apparatus according to the first embodiment of the present invention;

FIG. 6 is a map of program data in a recording device 103 in the recording and reproducing apparatus according to the second embodiment of the present invention;

FIG. 7 is a map of program data in a recording device 103 in the recording and reproducing apparatus according to the third embodiment of the present invention;

FIG. 8 is a map of program data in a recording device 103 in the recording and reproducing apparatus according to the fourth embodiment of the present invention;

FIG. 9 is a map of program data in a recording device 103 in the recording and reproducing apparatus according to the fifth embodiment of the present invention;

FIG. 10 is a map of program data in a recording device 103 in the recording and reproducing apparatus according to the sixth embodiment of the present invention;

FIG. 11 is a map of program data in a recording device 103 in the recording and reproducing apparatus according to the seventh embodiment of the present invention;

FIG. 12 is a map of program data in a recording device 103 in the recording and reproducing apparatus according to the eighth embodiment of the present invention;

FIG. 13 is a block diagram showing a configuration of a time shift reproduction apparatus of a conventional example; and

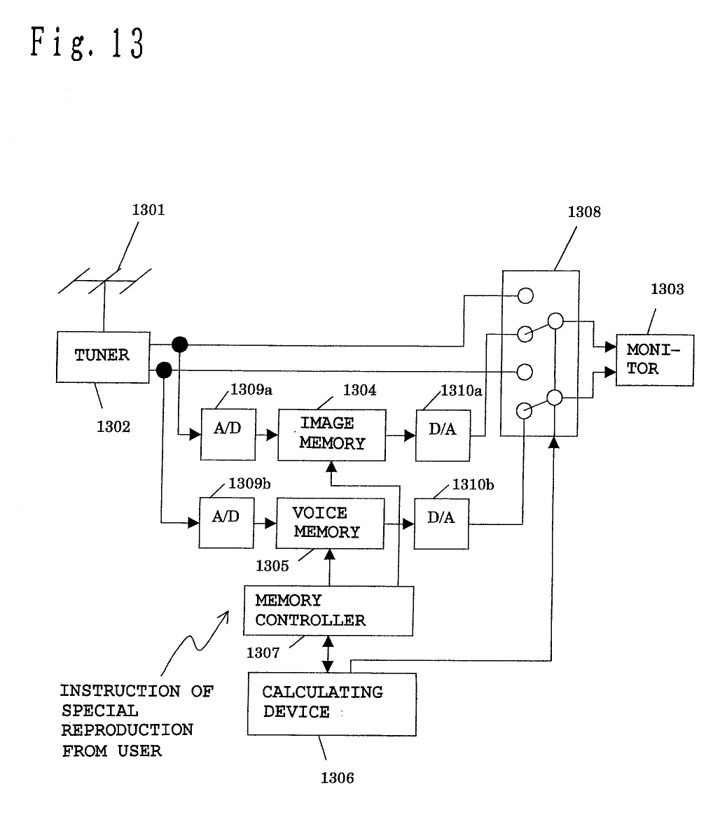

FIG. 14 is a map of program data in a memory in the time shift reproduction apparatus of the conventional example.

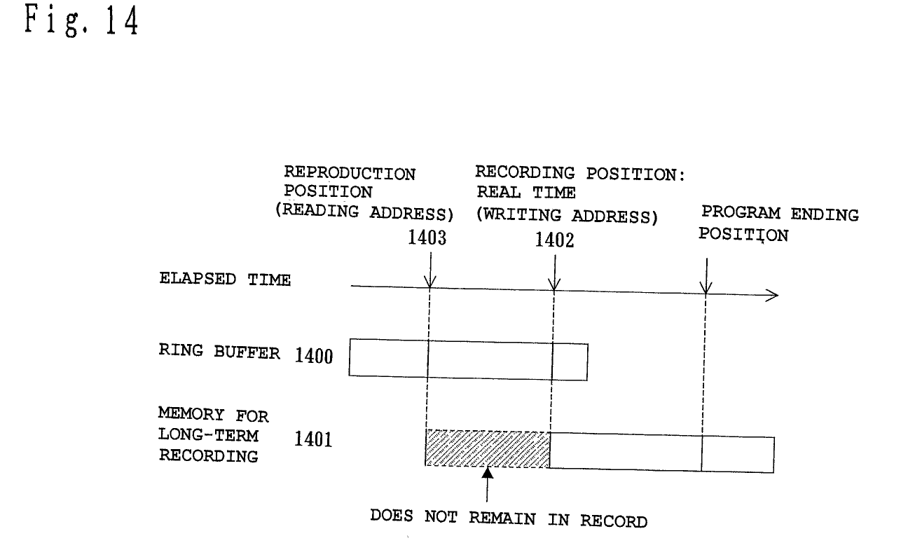

Description of Symbols

101, 201, 301 Receiving unit

102, 202, 302 Encoder

203, 303 Recording device

204, 304 Recording device control unit

205, 305 Decoder

206, 306, 1303 Monitor

307, 407 Input section

208 Ending time detecting unit

209 Display control unit

308, 408 Image quality control unit

309, 409 Re-encoding unit

410 Scene change detecting unit

1301 Antenna

1302 Tuner

1304 Image memory

1305 Voice memory

1306 Calculating device

1307 Memory controller

1308 Alteration switch

### DETAILED DESCRIPTION OF THE PREFERRED EMBODIMENTS

Embodiments of the present invention will be hereinafter described with reference to the accompanying drawings.

[First Embodiment]

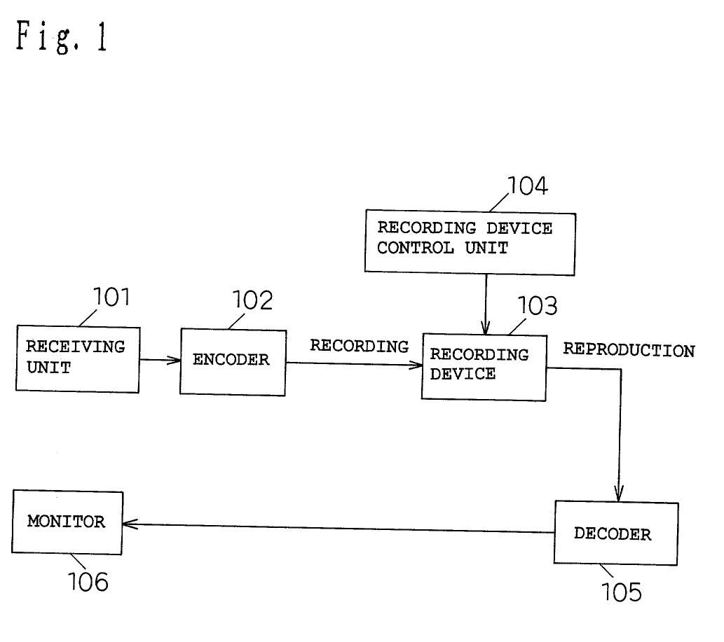

FIG. 1 is a block diagram of a recording and reproducing apparatus according to a first embodiment of the present invention. In a recording and reproducing apparatus 100, a receiving unit 101 is means for receiving program data from the not-shown outside, an encoder 102 is means for encoding program data, a recording device 103 is means for recording and reproducing data outputted from the encoder 102, which is implemented by a hard disc, a recording device control unit 104 is means for controlling record reproduction of data on the recording device 103 and managing a recording area on the recording device 103, a decoder 105 is means for decoding data outputted from the recording device 103 and a monitor 106 is means for displaying data outputted from the decoder 105.

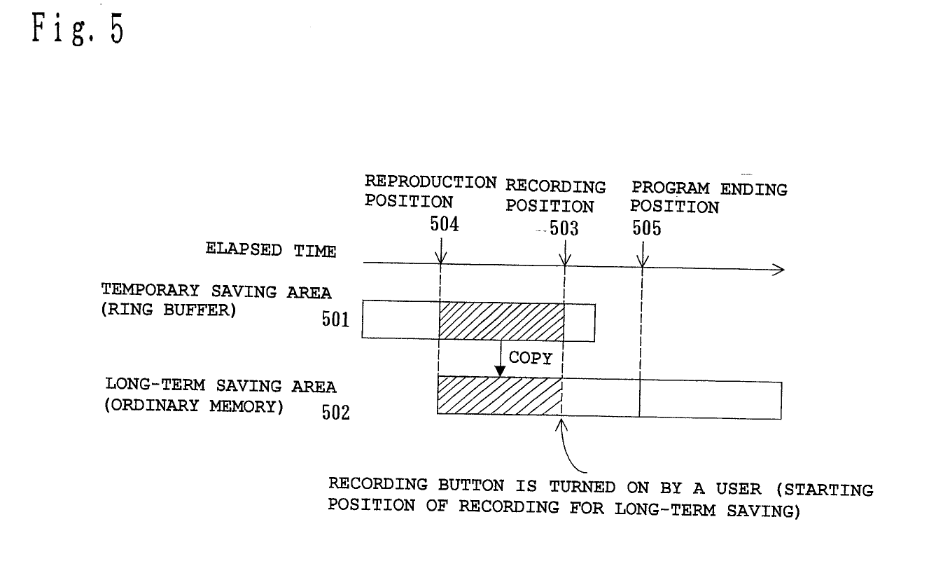

In addition, FIG. 5 is a map for illustrating a state of a data recording area on the recording unit 103. In the drawing, the data recording area in the recording device 103 is set divided into two recording areas, namely a temporary saving area 501 for temporarily recording program data inputted from the encoder 102 and a long-term saving area 502 in which a user records desired program data for a long term.

The temporary saving area 501 is a ring buffer of a fixed length, in which a user temporarily records program data that the user is viewing at any time. The long-term saving area 502 is an area in which a user records program data that the user reserves for video recording or records program data for a long term by the control of the recording device control unit 104 while the user is viewing a program via the monitor 106.

Operations of the recording and reproducing apparatus according to the first embodiment of the present invention having the configuration as above will be hereinafter described with reference to FIGS. 1 and 5.

First, when the receiving unit 101 receives program data such as videos, voices or the like, the received program data is sent to the encoder 102. The encoder 102 encodes the sent program data and records the encoded data in a predetermined recording area of the recording device 103 designated by the recording device control unit 104.

The program data is then taken out from an area of the recording device 103 designated by the recording device control unit 104 and sent to the decoder 105. The decoder 105 decodes the sent program data and output the decoded program data to the monitor 106.

At this time, the recording device control unit 104 can designate a recording address and a reproducing address of the recording device 103 separately. Thus, time shift reproduction becomes possible which starts reproduction of program data recorded in the recording device 103 from an address that is the same as or different from an address at the recording time.

As described with reference to FIG. 1, if a user performs a special reproduction such as rewinding and pause while the user is viewing the time shift reproduction of a program, a recording position 503 of program data to be outputted from the encoder 102 and a reproduction position 504 of program data to be outputted to the decoder 105 is different on a recording area in a temporary saving area 501.

If the user tries to permanently record a program that the user is viewing by the time shift reproduction in that state, the recording device controlling unit 104 copies program data, which is recorded in the reproduction position 504 to the recording position 503 of the temporary saving area 501, to a predetermined position on the long-term saving area 502 and subsequently records the program data that the receiving unit 101 receives on the long-term saving area 502 for a long term. The end of the long-term recording in the long term saving area 502 may be by means of the user's control or an automatic control based on an EPG or the like included in the program data.

In this way, according to this embodiment, even if a recording position and a reproduction position are different during the time shift reproduction using a temporary saving area that is a ring buffer, program data temporarily recorded in the temporary saving area is copied in a long-term saving area, whereby recording of program data that a user tries to record can be started from a temporal position at which the user is actually viewing a program by the monitor 106.

Further, although program data from the reproduction position 504 to the recording position 503 of the temporary saving area 501 is copied to the long-term saving area 502 in the above-mentioned description of the first embodiment, this embodiment can also be implemented in the same manner if program data is copied from the starting position or an arbitrary position of the temporary saving area 501.

In addition, although program data temporarily recorded on the temporary saving area 501 is copied to the long-term saving area 502 starting from the time when the user performs a control for video recording and subsequently a long-term recording of program data to be received in the long-term saving area 502 is performed in the above-mentioned description of the first embodiment, this embodiment can also be implemented in the same manner if program data temporarily recorded in the temporary saving area 501 is copied to the long-term saving area 502 after ending long-term recording of program data to the long-term saving area 502 starting at the time when the user performs a control for video recording. In addition, this embodiment can also be implemented in the same manner if temporary recording is continued until immediately before program data in the temporary saving area 501 is erased by overwriting and then the program data in the temporary saving area 501 is copied to the long-term saving area 502 immediately before overwriting it.

In addition, although program data from a reproduction position to a recording position of a temporary saving area is copied in a long-term saving area and subsequently a program is recorded for a long-term in the long-term saving area until the end of the program in the above-mentioned description of the first embodiment, this embodiment can also be implemented in the same manner if program data in the temporary saving area is copied to the long-term saving area after the program is temporarily stored in the temporary saving area until the end of the program. In particular, in this case, it is desirable to make the ring buffer of the temporary saving area 501 to have a variable length rather than a fixed length.

[Second Embodiment]

A recording and reproducing apparatus according to a second embodiment of the present invention is an apparatus for changing a temporary saving area set in a recording device to a long-term saving area, thereby recording program data that a user is currently viewing from an arbitrary position.

Since a configuration of the recording and reproducing apparatus according to the second embodiment of the present invention is the same as that of the first embodiment, it is described with reference to FIG. 1.

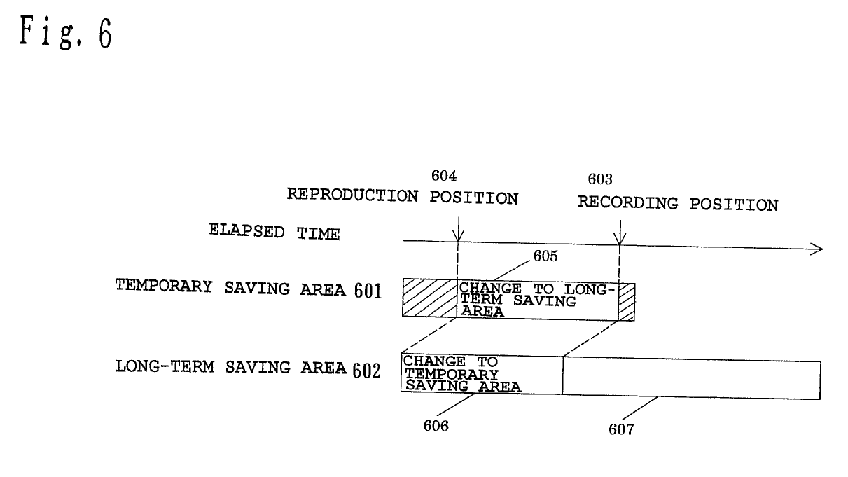

In addition, FIG. 6 is a map for illustrating a state of a data recording area on the recording device 103 in this embodiment. As shown in the drawing, the recording device control unit 104 sets the data recording area in the recording device 103 dividing it into two recording areas, namely a temporary saving area 601 for temporarily recording program data and a long-term saving area 602 for recording program data desired by a user for a long term. The temporary saving area 601 is a ring buffer of a fixed length, which is an area for temporarily recording program data that the user is viewing at any time. The long-term saving area 602 is an area for recording program data that the user reserves for video recording or recording program data for a long term when the user performs a control for video recording while the user is viewing a program. However, the recording device control unit 104 can dynamically manage the temporarily saving area 601 and the long-term saving area 602 in a recording area of the recording device 103.

Operations of the recording and reproducing apparatus according to the second embodiment of the present invention having the configuration as described above will be hereinafter described. However, features that the second embodiment has in common with the first embodiment will be omitted and only differences will be described.

As in the first embodiment, if the user performs a special reproduction such as rewinding and pause while the user is performing time shift reproduction of a program, a recording position 603 of program data and a reproduction position 604 of program data have different addresses on a recording area in the temporary saving area 601.

If the user tries to permanently record a program that the user is viewing by the time shift reproduction in this state, the recording device control unit 104 resets a recording area 605, which is held by program data recording from the reproduction position 604 to the recording position 603 in the temporary saving area 601 as a long-term saving area in a recording area in the recording device 103.

On the other hand, the recording device control unit 105 resets a recording area 606 having the equivalent size as the recording area 605, which was reset as the long-term saving area previously, as a temporary saving area in the long-term saving area 602.

After the resetting ends, the recording device control unit 105 records program data of a program, which is received by the receiving unit 101, for a long term in the long-term saving area 602. The end of the long-term recording in the long term saving area 602 maybe by means of the user's control or an automatic control based on an EPG or the like included in the program data as in the first embodiment.

In this way, according to this embodiment, even if a recording position and a reproduction position are different during the time shift reproduction using a temporary saving area that is a ring buffer, a recording area including temporarily recorded program data on the temporary saving area is reset as a long-term saving area, whereby recording of program data that a user tries to record can be started from a temporal position at which the user is actually viewing a program by the monitor 106.

Further, although a program data part from a reproduction position to a recording position of a temporary saving area is changed to a long-term saving area in the above-mentioned description of the second embodiment, this embodiment can also be implemented in the same manner if a program data part is changed from a starting position or an arbitrary position of the temporary saving area.

[Third Embodiment]

A recording and reproducing apparatus according to a third embodiment of the present invention is an apparatus that is capable of recording only program data that a user wishes to record by connecting predetermined pieces of data among program data recorded on a temporary saving area to copy them on a long-term saving area.

Since a configuration of the recording and reproducing apparatus according to the third embodiment of the present invention is the same as that of the first embodiment, it is described with reference to FIG. 1.

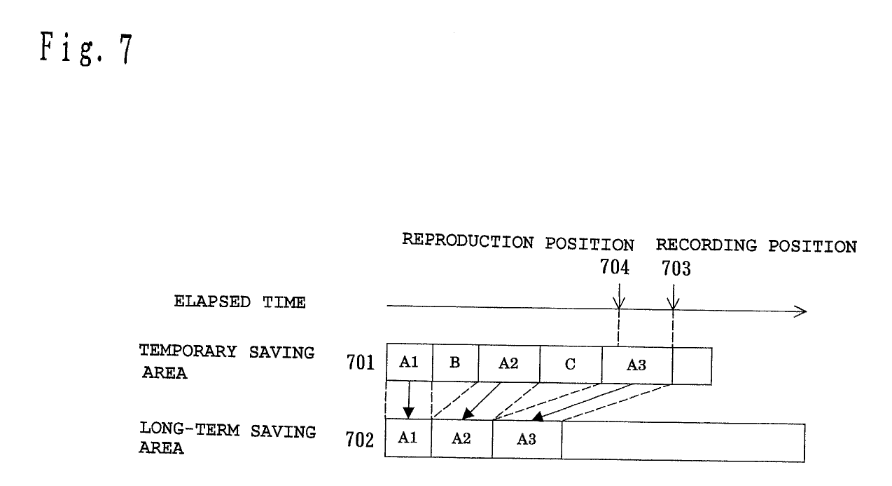

In addition, FIG. 7 is a map for illustrating a state of a data recording area on the recording device 103 in this embodiment. As shown in the drawing, the recording device control unit 104 sets the data recording area in the recording device 103 dividing it into two recording areas, namely a temporary saving area 701 for temporarily recording program data and a long-term saving area 702 for recording program data desired by a user for a long term. The temporary saving area 701 is a ring buffer of a fixed length, which is an area for temporarily recording program data that the user is viewing at any time. The long-term saving area 702 is an area for recording program data that the user reserves for video recording or recording program data for a long term when the user performs a control for video recording while the user is viewing a program.

Operations of the recording and reproducing apparatus according to the third embodiment of the present invention having the configuration as described above will be hereinafter described. However, features that the third embodiment has in common with the first embodiment will be omitted and only differences will be described.

First, it is assumed that the user is performing time shift reproduction of a program and is performing a special reproduction such as rewinding and pause. It is assumed that, at this point, the user is controlling the receiving unit 101 to perform the time shift reproduction while changing a program that the user views one after another, program data A1, program data B, program data A2 and program data C have already been temporarily recorded in the temporary saving area 701, and the user is currently viewing the program data A3, which the receiving unit 101 receives, by the time shift reproduction and the special reproduction. However, it is assumed that program data A1, A2 and A3 are program data of an identical program and program data B, program data C and program data A1 to A3 are program data different from each other.

In such a state, if the user tries to permanently record a program that the user is viewing, the recording device control unit 104 copies the program data A3 recorded from the reproduction position 704 to the recording position 503 of the temporary saving area 501 and the program data A1 and A2 recorded on the temporary saving area 701 to a predetermined position on the long-term saving area 703 and subsequently records the program data A3 of the program, which the receiving unit 101 receives, for a long term in the long term saving area 703 in the recording area in the recording device 103.

At this point, on the temporary saving area 701, identifications of the program data A1 to A3, the program data B and the program data C are recorded in advance in the temporary saving area 701 as information of a channel of a received program when the user controls the receiving unit 101 to change a program that the user is viewing together with the program data and the recording device control unit 104 refers to it in copying the program data.

In this way, according to this embodiment, only program data that a user wishes to record can be permanently recorded by connecting predetermined pieces of data among program data recorded on a temporary saving area to copy them on a long-term saving area.

Further, although only program data of a program identical with program data that the user is viewing is connected and copied to a long-term saving area when the user performs a control for video recording while the user is viewing a program in the description of the third embodiment of the present invention, the present invention can be implemented in the same manner whether a recording position and a reproduction position of a temporary saving area are the same (ordinary reproduction) or different as timing for the control for video recording by the user.

In addition, it is assumed that only program data of a program identical with program data that the user is viewing among program data temporarily recorded on the temporary saving area 701 is copied to the long-term saving area 702 from the time when the user performs a control for video recording and subsequently program data to be received is recorded for a long term in the long-term saving area 702 as in the first embodiment, this embodiment can also be implemented in the same manner if predetermined program data temporarily recorded in the temporary saving area 701 is connected to be copied to the long-term saving area 702 after the long-term recording of program data in the long-term saving area 702 ends from the time when the user performs a control for video recording. In addition, this embodiment can also be implemented if temporary recording is continued until immediately before program data in the temporary saving area 701 is erased by overwriting and then predetermined program data in the temporary saving area 701 is connected immediately before overwriting it and copied to the long-term saving area 702.

In addition, program data from a reproduction position to a recording position of a temporary saving area is copied to a long-term saving area and subsequently the program data is recorded for a long term in the long-term saving area until the end of a program in the third embodiment of the present invention, this embodiment can also be implemented in the same manner if predetermined program data in the temporary saving area is connected and copied to the long-term saving area after program data is temporarily recorded in the temporary saving area until the end of a program. It is particularly desirable to set the ring buffer of the temporary saving area 701 at a variable length rather than a fixed length in this case.

In addition, although a change of a channel or the like in changing program data to be received in the receiving unit 101 is used as information for identification of program data recorded in the temporary saving area 701 in the description of the above-mentioned embodiment, the present invention is not limited to this embodiment but, for example, an EPG included in program data or associated with the separately recorded program may be used.

In addition, although information of a channel of a program for identifying program data is described as recording the program data in the temporary saving area 701 in the description of the above-mentioned embodiment, this information may be separately recorded not only in the temporary saving area 701 but also in the long term saving area 702 or not-shown other recording means.

[Fourth Embodiment]

A fourth embodiment of the present invention is for deleting program data in a temporary saving area at the ending time of a program detected from an EPG.

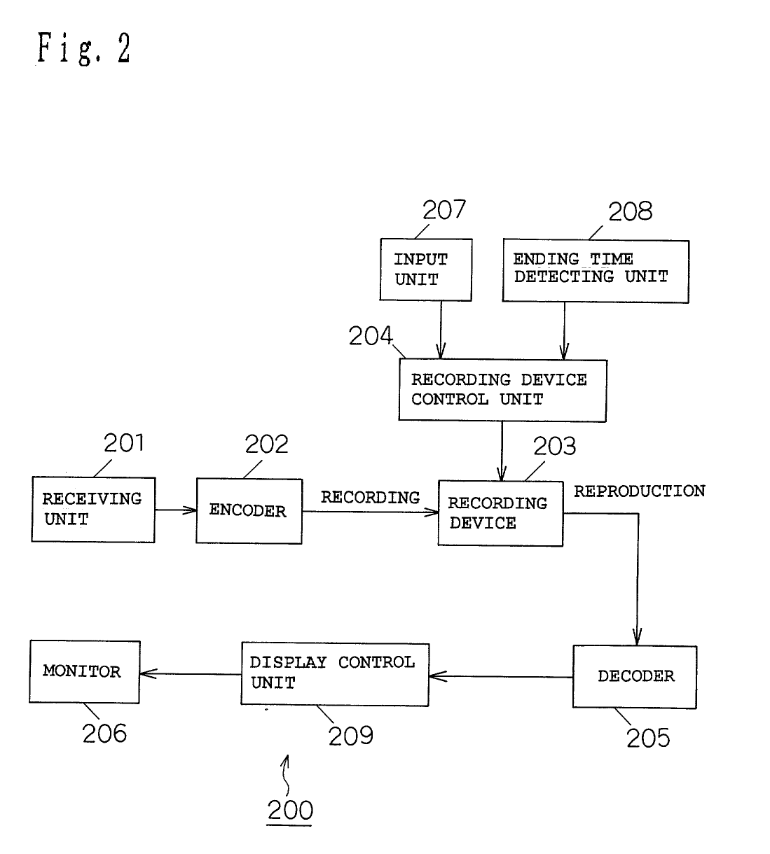

FIG. 2 is a block diagram of a recording and reproducing apparatus according to the second embodiment of the present invention. In a recording and reproducing apparatus 200, a receiving unit 201 is means for receiving program data from the not-shown outside, an encoder 202 is means for encoding program data, a recording device 203 is means for record reproducing data and an EPG outputted from the encoder 202, a recording device control unit 204 is means for controlling record reproduction of data on the recording device 203 and managing a recording area on the recording device 203, a decoder 205 is means for decoding data outputted from the recording device 203 and a monitor 206 is means for displaying data outputted from the decoder 205, an input unit 207 is means for performing an input for a control with respect to the recording device control unit 204, and an ending time detecting unit 208 is means for detecting an ending time. However, configurations other than the input unit 207 and the ending time detecting unit 208 are the same as those in the first embodiment.

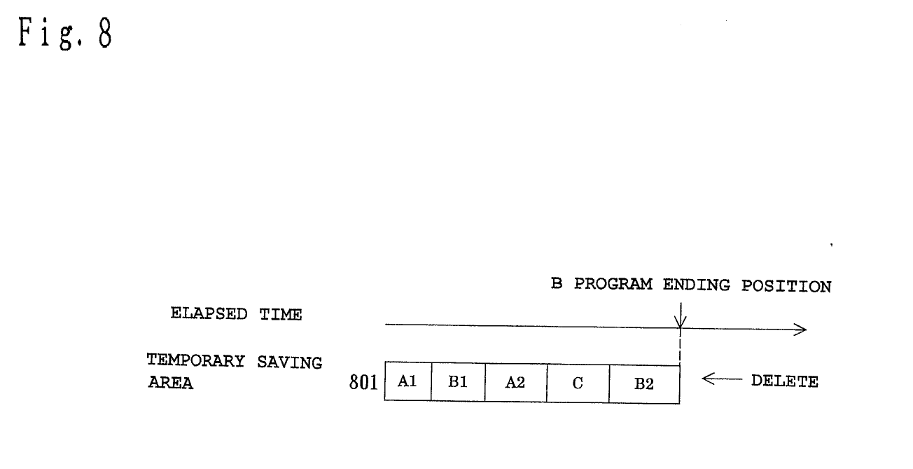

In addition, FIG. 8 is a map for illustrating a state of a data recording area on the recording unit 203. In the drawing, in the data recording area in the recording device 203, a temporary saving area 801 for temporarily recording program data to be inputted from the encoder 202 is set. In addition, although the same long-term saving area as in the first embodiment is also set in the data recording area, a description of the long-term saving area is omitted for simplicity.

Operations of the recording and reproducing apparatus according to the fourth embodiment of the present invention having the configuration as described above will be hereinafter described. However, features that the fourth embodiment has in common with the first embodiment will be omitted and only differences will be described.

First, it is assumed that a user controls the receiving unit 101 to change a program that the user views one after another, program data A1, program data B, program data A2 and program data C have already been recorded in the temporary saving area 801 and the user is currently viewing the program data B2 that the receiving unit 201 receives. In addition, it is assumed that an EPG is stored in the recording device 203 in advance. Further, an EPG may be obtained from program data that is being broadcasted or may be obtained via other recording media, a telephone line or the like and a method of obtaining it is not specifically limited.

While the user is viewing a program, when the ending time detecting unit 208 detects an ending time of the program that the user is viewing by an EPG of the program data B2 of the program stored in the recording device 203 based on an instruction from the recording device control unit 204, the recording device control unit 204 indicates on the monitor 206 by a display control unit 209 that that the program data A1, B1, A2, C and B2 recorded on the temporary saving area 801 is to be deleted and informs the user to that effect. The recording device control unit 204 determines that the program data on the temporary saving area 801 is to be deleted by a user's input operation from the input unit 207 and deletes all program data recorded on the temporary saving area 801 in the recording device 203.

As described above, according to this embodiment, the user can delete program data in a temporary saving area based on an EPG whenever the user wishes to do so.

Further, although an ending time of a program that a user is viewing is detected by an EPG in the description of the fourth embodiment of the present invention, this embodiment can also be implemented in the same manner if an ending time of any one of programs temporarily recorded in a temporary saving area.

In addition, although program data in a temporary saving area is deleted by an input operation of a user in the fourth embodiment of the present invention, this embodiment can also be implemented in the same manner if program data is deleted automatically.

In addition, although this embodiment is described as an addition of the input unit 207 and the ending time detecting unit 208 to the configuration of the first embodiment, this embodiment may be implemented in the second or the third embodiment.

[Fifth Embodiment]

In a fifth embodiment of the present invention, the user can record only program data that the user wishes to record and delete program data at an ending time of each program by preparing a plurality of temporary saving files in a temporary saving area.

Since a configuration of a recording and reproducing apparatus according to the fifth embodiment of the present invention is the same as that of the fourth embodiment, it is described with reference to FIG. 2.

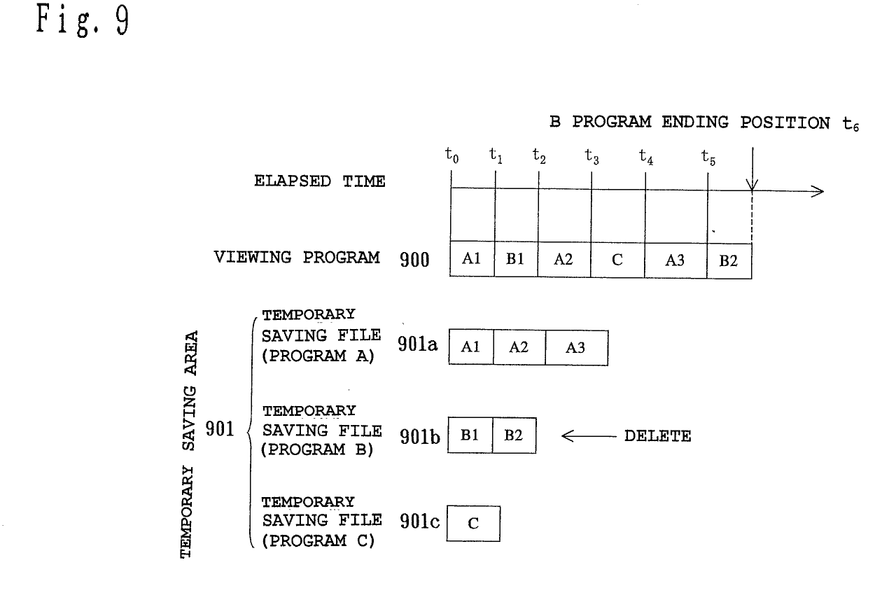

In addition, FIG. 9 is a map for illustrating a status of a data recording area on the recording device 203. In the drawing, a temporary saving area 901 for temporarily recording program data to be inputted from the encode 202 is set in the data recording area in the recording device 203. In addition, although a long-term saving area similar to that in the first embodiment is set in the data recording area, a description of the long-term saving area is omitted in this embodiment for simplicity.

Moreover, the temporary saving area 901 is composed of temporary saving files 901a, 901b and 901c of a variable length. Program data belonging to one program is temporarily recorded in one temporary saving file.

Operations of the recording and reproducing apparatus according to the fifth embodiment of the present invention having the configuration as described above will be hereinafter described. However, features that the fifth embodiment has in common with the first or the fourth embodiments will be omitted and only differences will be described.

First, it is assumed that a user controls the receiving unit 201 to change a program that the user views one after another. As shown in FIG. 9, it is assumed that, if the user is viewing a program A at the point of a time t0, the receiving unit 201 receives program data A1 of the program A and the program data A1 is temporarily recorded in the temporary saving area 901 of the recording device 203. Moreover, it is assumed that an EPG is stored in the recording device 203 in advance. Further, the EPG may be obtained from program data that is being broadcasted or may be obtained via other recording media, a telephone line or the like and a method of obtaining the EPG is not specifically limited.

Then, at a time t1, when it is assumed that the user controls the receiving unit 201 to start viewing a program B, an area for holding a program data A1 that has already been temporarily saved is set as a temporary saving file 901a on the temporary saving area 901 by the control of the recording device control unit 204. A program data B1 to be received from the receiving unit 201 is temporarily recorded in a new area on the temporary saving area 901 and, at the same time, an area for holding this program data B1 is set as a temporary saving file 901b.

Subsequently, at a time t2, when it is assumed that the user controls the receiving unit 201 to resume viewing of the program A, a program data A2 to be received from the receiving unit 201 is temporarily recorded in the temporary saving file 901a, which has already been set, by the control of the recording device control unit 204.

Thereafter, according to the control of the receiving unit 201, every time a program of program data to be received is changed, a new temporary saving file for saving program data is set (at a time t3, a temporary saving file 901c for temporarily recording program data C is set) or a temporary saving file to be a file for saving program data is switched (between a time t4 and a time t5, program data A3 is temporarily recorded in the temporary saving file 901a).

Then, while the user is viewing the program, if the ending time detecting unit 208 detects an ending time t6 of the program B from an EPG stored in the recording device 203 based on an instruction from the recording device control unit 204, the recording apparatus control unit 204 indicates that the temporary saving file 901b temporarily recording program data B1 and B2 of the program B is to be deleted on the monitor 206 by the display control unit 209 to inform the user to that effect.

It is determined that the temporary saving file 901b is to be deleted by an input operation of the user from the input unit 207.

As described above, according to this embodiment, a user can temporarily record program data for each program and, at the same time, can record only program data that the user wishes to record and delete program data that is temporarily recorded at an ending time of each program by preparing a plurality of temporary saving file in a temporary saving area.

Further, although, when an ending time of a program that a user is viewing, that is, a program that the receiving unit 201 is currently receiving is detected from an EPG stored in the recording device 203, a temporary saving file that temporarily records program data of the program is deleted in the fifth embodiment of the present invention, even if at an ending time of any one of programs of a temporary saving file temporarily recorded in the temporary saving area 901 detected by an EPG, a temporary saving file in which program data of a program that has reached the ending time are contained can be deleted in the same manner.

In addition, although a temporary saving file is deleted by an input operation of a user in the fifth embodiment, this embodiment can also be implemented in the same manner if a temporary saving file is automatically deleted.

[Sixth Embodiment]

A sixth embodiment of the present invention is for making image qualities of program data uniform by re-encoding a file of program data in which an image quality is different in the middle.

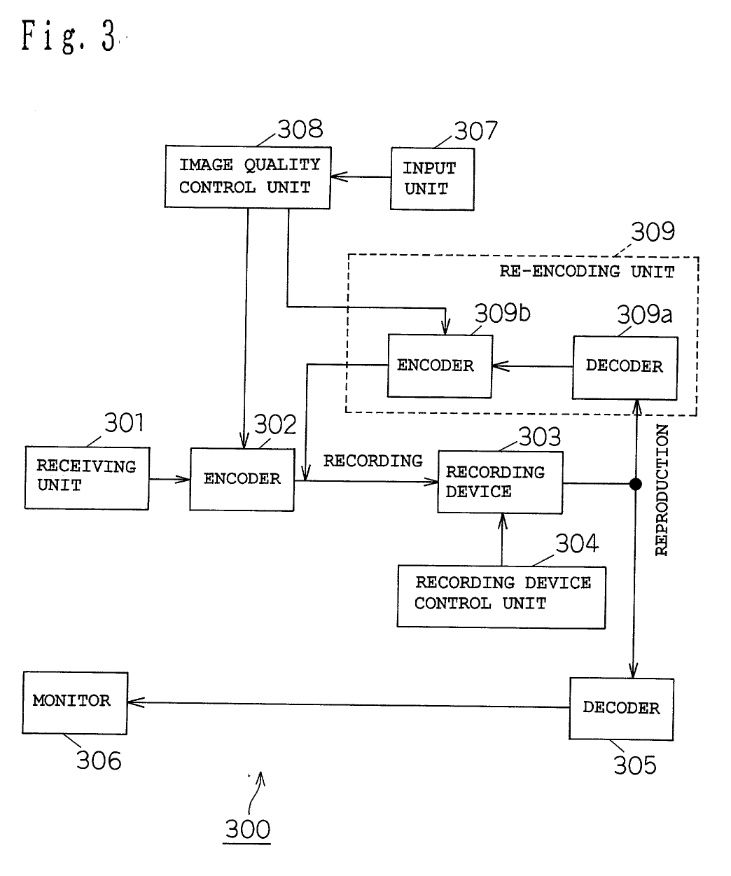

FIG. 3 is a block diagram of a recording and reproducing apparatus according to the sixth embodiment of the present invention. In a recording and reproducing apparatus 300, a receiving unit 301 is means for receiving program data from the not-shown outside, an encoder 302 is means for encoding program data, a recording device 303 is means for recording and reproducing data outputted from the encoder 302, a recording device control unit 304 is means for controlling record reproduction of data on the recording device 303 and managing a recording area on the recording device 303, a decoder 305 is means for decoding data outputted from the recording device 303, a monitor 306 is means for displaying data outputted from the decoder 305, an input unit 307 is means for performing an input for a control with respect to an image quality control unit 308, an image quality control unit 308 is means for controlling an image quality and a re-encoding unit 309 is means for re-encoding program data reproduced from the recording device 303. In addition, the re-encoding unit 309 has a decoder 309a and an encoder 309b. However, in the above-mentioned configuration, configurations other than the input 307, the image quality control unit 308 and the re-encoding unit 309 are the same as those in the first embodiment.

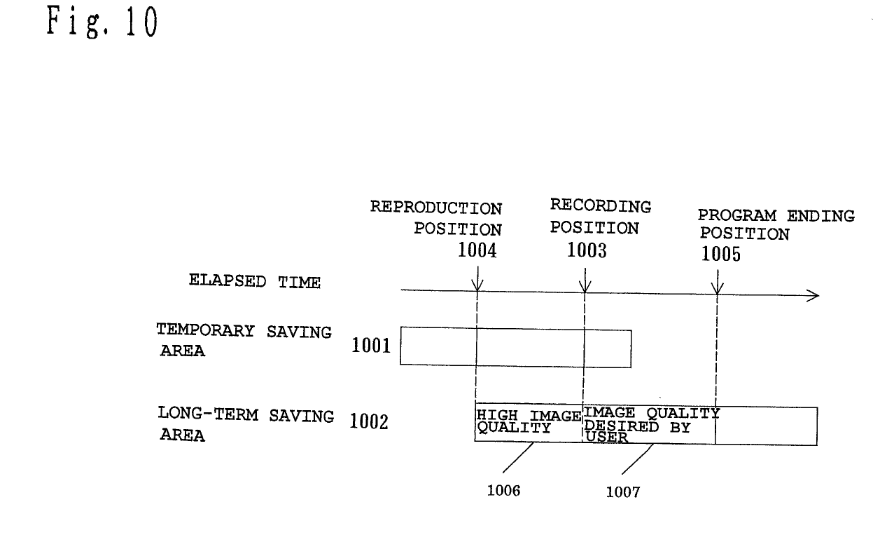

In addition, FIG. 10 is a map for illustrating a state of a data recording area on the recording unit 303. In the drawing, the data recording area in the recording device 303 is set divided into two recording areas, namely a temporary saving area 1001 for temporarily recording program data inputted from the encoder 302 and a long-term saving area 1002 in which a user records desired program data for a long term.

The temporary saving area 1001 is a ring buffer of a fixed length, in which a user temporarily records program data that the user is viewing at any time. The long-term saving area 1002 is an area in which a user records program data that the user reserves for video recording or records program data for a long term by the control of the recording device control unit 304 while the user is viewing a program via the monitor 306.

Operations of the recording and reproducing apparatus according to the sixth embodiment of the present invention having the configuration as above will be hereinafter described with reference to FIGS. 3 and 10. However, features that the second embodiment has in common with the first embodiment will be omitted and only differences will be described.

First, if an ordinary recording operation that is not a time shift reproduction is performed, it is assumed that program data that the receiving unit 301 has received is encoded by the encoder 302 with an image quality desired by a user set by the image quality control unit 308 according to an input operation of the user from the input unit 307 and then recorded for a long term in the long-term saving area 1002.

At this point, an image quality that the user can set is only an image quality that is lower than an image quality temporarily recorded in a temporary saving area.

Then, if the user has performed a special reproduction such as rewinding and pause while the user is viewing a program by a time shift reproduction, a recording position 1003 of program data to be outputted from the encoder 302 and a reproduction position 1004 of program data to be reproduced from the recording device 303 have different addresses on a recording area in the temporary saving area 1001.

In this state, if the user tries to permanently record a program that the user is viewing by the time shift reproduction in that state, the recording device controlling unit 304 copies program data, which is recorded in from the reproduction position 1004 to the recording position 1003 of the temporary saving area 1001, to a predetermined position on the long-term saving area 1002 and subsequently records a program data of a program on the long-term saving area 1002, which the receiving unit 301 receives, for a long term in a recording area in the recording device 303.

In the above-mentioned operation, if an image quality of a program data temporarily recorded in a temporary saving area and an image quality desired by a user set in advance by the user in recording program data for a long-term recording in the long-term saving area 1002 are different, an image quality varies in the middle of identical program data. As shown in the drawing, in the long-term saving area 1002, program data copied from the temporary saving area 1001 is high image quality data 1006 and data recorded after switching from the time shift reproduction to a recording operation is data of the image quality desired by the user 1007.

In that case, after the recording of the program data ends, only high image quality data 1006 is reproduced from the recording device 303 and the high image quality data 1006 is encoded by the encoder 309b after the high image quality data 1006 is once decoded in the decoder 309a in the re-encoding unit 309. In doing so, after the high image quality data 1006 is encoded with a low image quality by the control of the image quality control unit 308 and the image quality of the program data is converted into the image quality desired by the user, the image quality desired by the user is overwritten and recorded in the corresponding part on the long-term saving area 1002 of the recording device 303. As a result, the image quality of the high image quality data 1006 is made equal to the data of the image quality desired by the user 1007.

As described above, according to this embodiment, even if an image quality of program data temporarily recorded in a temporary saving area is different from an image quality designated by a user for saving the program data for a long term, an image quality of program data to be recorded can be made equal by re-encoding it.

Further, although the temporary saving area 1001 is an area for temporarily recording program data that a user is viewing at any time in the description of the sixth embodiment of the present invention, the present invention can be implemented in the same manner whether an image quality to be temporarily recorded in the temporary saving area 1001 is a highest image quality among image qualities that can be set.

In addition, although the program data from the reproduction position 1004 to the recording position 1003 of the temporary saving area 1001 is copied to the long-term saving area 1002 in the sixth embodiment of the present invention, this embodiment can also be implemented in the same manner if the program data is copied from the starting position or an arbitrary position of the temporary saving area 1001.

In addition, although the program data temporarily recorded on the temporary saving area 1001 is copied to the long-term saving area 1002 from the time when the user performs a control for video recording and subsequently the program data to be received in the long-term saving area 1002 is recorded for a long term in the above-mentioned embodiment, the present invention can be implemented in the same manner if the program data temporarily recorded in the temporary saving area 1001 is copied to the long-term saving area 1002 after the long-term recording of the program data in the long-term saving area 1002 ends from the time when the user performs a control for video recording. In addition, the present invention can be implemented in the same manner if the temporary recording is continued until immediately before the program data on the temporary saving area 1001 is erased by overwriting and then the program data of the temporary saving area 1001 is copied to the long-term saving area 1002 immediately before overwriting it.

In addition, although program data from a reproduction position to a recording position of a temporary saving area is copied to a long-term saving area and subsequently the program data is recorded for a long term in the long-term saving area until the end of a program in the sixth embodiment, this embodiment can also be implemented if program data in a temporary saving area is copied to a long-term saving area after the program data is temporarily recorded in the temporary saving area until the end of the program. In particular, at this point, it is desirable to set the ring buffer of the temporary saving area 1001 at a variable length rather than a fixed length.

In addition, although this embodiment is described as an addition of the input unit 307, the image quality control unit 308 and the re-encoding unit 309 to the configuration of the first embodiment, this embodiment may be implemented in the configuration of the second embodiment and can also be implemented in the same manner if a program data portion is reset in a long-term saving area from a starting position or an arbitrary position of a temporary saving area in the long-term saving area.

In addition, although a conversion of an image quality is performed immediately after recording of program data ends in the description of the above-mentioned embodiment, this embodiment can also be implemented if conversion of an image quality is automatically performed when other recording processing is not performed after the program ends.

In addition, although conversion of an image quality is performed in the re-encoding unit 309 in the sixth embodiment, this embodiment can also be implemented if program data shown by a chain line in the drawing is circulated and re-encoding of the program data is executed using the decoder 305 and the encoder 302.

[Seventh Embodiment]

A seventh embodiment of the present invention is for recording program data by changing an image quality of program data to an image quality designated by the user at a change of scenes in the above described sixth embodiment.

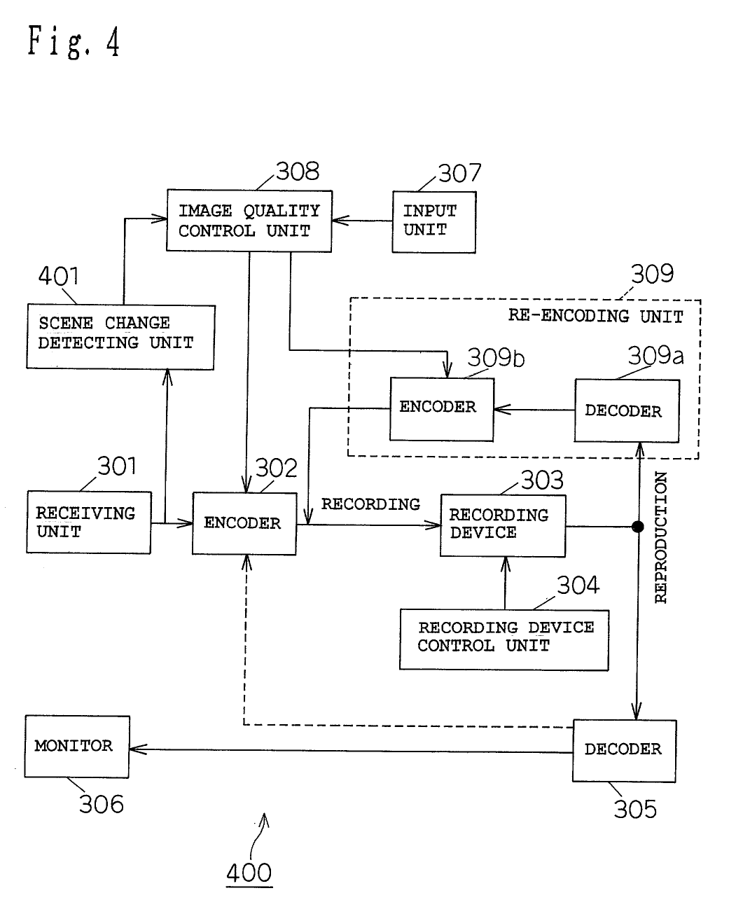

FIG. 4 is a block diagram of a recording and reproducing apparatus according to the seventh embodiment of the present invention. In a recording and reproducing apparatus 400, parts identical with or equivalent to those of FIG. 3 are denoted by the identical reference numerals and a description of the parts is omitted. In addition, a scene change detecting unit 401 is means for obtaining program data from the receiving unit 301, detecting a change of scenes and outputting the timing of the detection to the image quality control unit 308. However, here, the scene change refers to a change between a CM and a program in program data, a change of luminance or color differences of an image to be displayed or voice data in the program data and a change of a differential for each frame in the case of compressed data such as an MPEG. The scene change detecting unit 308 is for detecting a change of this differential.

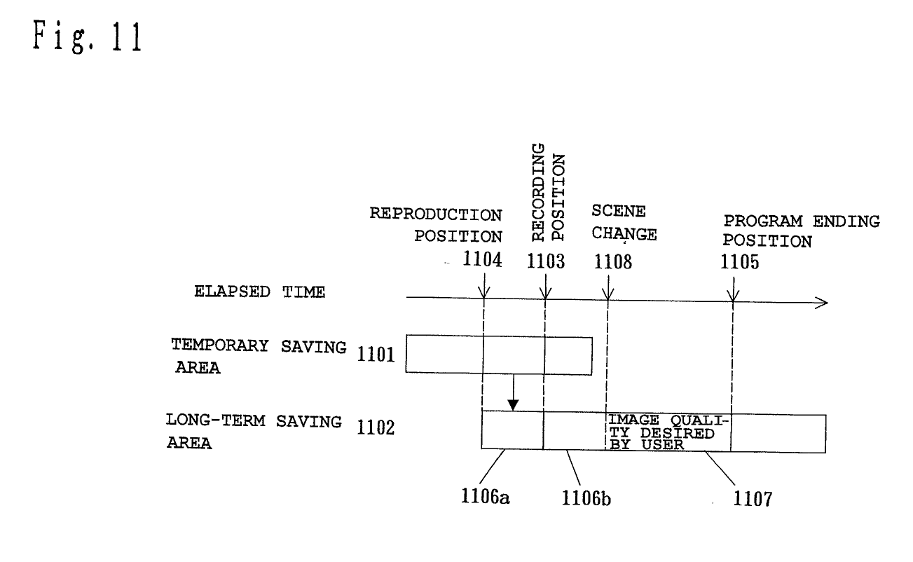

In addition, FIG. 11 is a map for illustrating a state of a data recording area on the recording unit 303. In the drawing, the data recording area in the recording device 303 is set divided into two recording areas, namely a temporary saving area 1101 for temporarily recording program data inputted from the encoder 302 and a long-term saving area 1102 in which a user records desired program data for a long term.

The temporary saving area 1101 is a ring buffer of a fixed length, in which a user temporarily records program data that the user is viewing at any time. The long-term saving area 1102 is an area in which a user records program data that the user reserves for video recording or records program data for a long term by the control of the recording device control unit 304 while the user is viewing a program via the monitor 306.

Operations of the recording and reproducing apparatus according to the seventh embodiment of the present invention having the configuration as above will be hereinafter described with reference to FIGS. 4 and 11. However, features that the seventh embodiment has in common with the sixth embodiment will be omitted and only differences will be described.

First, in this embodiment, it is assumed that a time shift reproduction is performed and program data received by the receiving unit 301 is temporarily recorded in the temporary saving area 1101 of the recording device 303 with a high image quality.

Then, if the user tries to permanently record a program that the user is viewing by the time shift reproduction in that state, the recording device controlling unit 304 copies program data, which is recorded from the reproduction position 1104 to the recording position 1103 of the temporary saving area 1101, to a predetermined position on the long-term saving area 1102 as high image quality data 1106a and subsequently records a program data of a program that the receiving unit 301 receives for a long term on the long-term saving area 1102 as high image quality data 1106b of the same image quality as image quality with respect to the temporary saving area 1101 in a recording area in the recording device 303.

Then, when a scene change detecting unit 410 detects a scene change in program data to be received, the image quality control unit 308 switches from a high image quality to an image quality desired by the user that the user designates in encoding the received data and program data to be received after a scene change 1108 is received as data of an image quality desired by the user 1107 in the recording device 303.

In addition, if an image quality of a program data temporarily recorded in a temporary saving area and an image quality designated by a user are different, an image quality varies in the middle of identical program data. In this case, as in the sixth embodiment, an image quality of program data is made equal by converting a program data portion of a high image quality to a low image quality in the re-encoding unit 309 after recording of the program data ends.

In this way, according to this embodiment, a user can convert an image quality into an image quality designated by the user for ordinary recording without incongruity at a change of scenes while the user is viewing a program after performing ordinary recording from time shift reproduction.

Further, although the temporary saving area 1101 is an area in which a user temporarily records program data that the user is viewing at any time in the description of the seventh embodiment, this embodiment can also be implemented in the same manner if an image quality of an image to be temporarily recorded in the temporary saving area 1101 is a highest image quality among image qualities that can be set.

In addition, although the program data from the reproduction position 1104 to the recording position 1103 of the temporary saving area 1101 is copied to the long-term saving area 1102 in the description of the seventh embodiment, this embodiment can also be implemented in the same manner if program data is copied from the starting position or an arbitrary position of the temporary saving area 1101.

In addition, although it is assumed that the program data temporarily recorded on the temporary saving area 1101 is copied to the long-term saving area 1102 from the time when the user performs a control for video recording and subsequently the program data to be received in the long-term saving area 1102 is recorded for a long term in the description of the above-mentioned embodiment, this embodiment can also be implemented if the program data temporarily recorded in the temporary saving area 1101 is copied to the long-term saving area 1102 after the long-term recording of the program data in the long-term saving area 1102 ends from the time when the user performs a control for video recording. In addition, the embodiment can also be implemented if the temporary recording is continued until immediately before the program data in the temporary saving area 1101 is erased by overwriting and then the program data in the temporary saving area 1101 is copied to the long-term saving area 1102 immediately before overwriting it.

In addition, although program data from a reproduction position to a recording position of a temporary saving area is copied to a long-term saving area and subsequently the program data is recorded for a long term in the long-term saving area until the end of a program in the seventh embodiment, this embodiment can also be implemented if program data in a temporary saving area is copied to a long-term saving area after the program data is temporarily recorded in the temporary saving area until the end of the program. In particular, at this point, it is desirable to set the ring buffer of the temporary saving area 1001 at a variable length rather than a fixed length.

In addition, although this embodiment is described as an addition of the input unit 307, the image quality control unit 308 and the re-encoding unit 309 to the configuration of the first embodiment, this embodiment may be implemented in the configuration of the second embodiment and can also be implemented in the same manner if a program data portion is reset in a long-term saving area from a starting position or an arbitrary position of a temporary saving area.

In addition, although a conversion of an image quality is performed immediately after recording of program data ends in the description of the above-mentioned embodiment, this embodiment can also be implemented if conversion of an image quality is automatically performed when other recording processing is not performed after the program ends.

In addition, although conversion of an image quality is performed in the re-encoding unit 309 in the seventh embodiment, this embodiment can also be implemented if program data shown by a chain line in the drawing is circulated and re-encoding of the program data is executed using the decoder 305 and the encoder 302.

In addition, if data received by the receiving unit is compressed digital data of MPEG or the like, this embodiment may have a configuration in which the encoder 302 is omitted and conversion of an image may be performed in decoding by the re-encoding unit 309 to re-encode compressed data that is once accumulated in the recording device 303 when the scene detecting unit 401 detects a change of a differential from the data received by the receiving unit 301.

[Eighth Embodiment]

An eighth embodiment of the present invention is for performing recording until an end of a program with an image quality with which images are temporarily recorded in a temporary saving area and thereafter re-encoding it to convert the image quality to an image quality designated by a user.

Since a configuration of the recording and reproducing apparatus according to the eighth embodiment of the present invention is the same as that of the sixth embodiment, it is described with reference to FIG. 3.

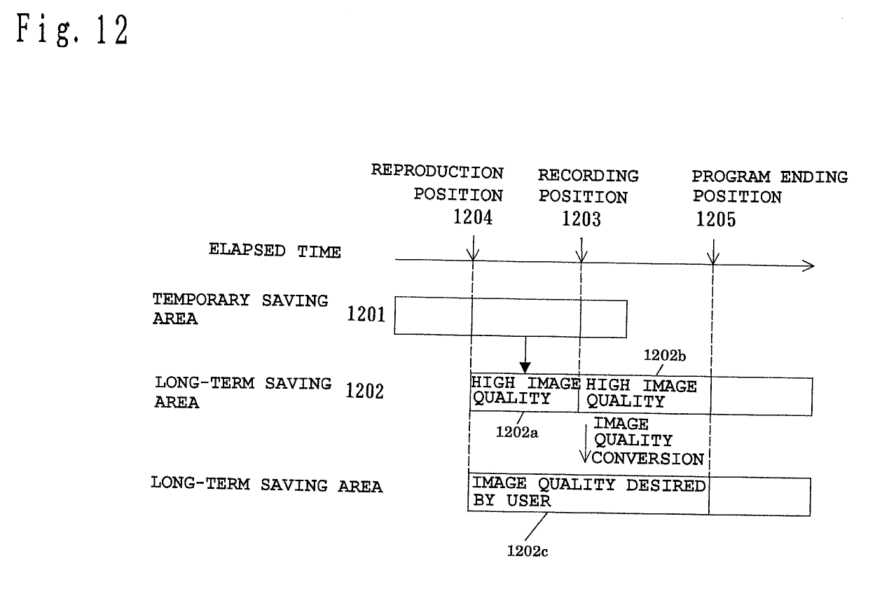

In addition, FIG. 12 is a map for illustrating a state of a data recording area on the recording device 303 in this embodiment. As shown in the drawing, the data recording area in the recording device 303 is set divided into two recording areas, namely a temporary saving area 1201 for temporarily recording program data to be inputted from the encoder 302 and a long-term saving area 1202 for recording program data desired by a user for a long term.

The temporary saving area 1201 is a ring buffer of a variable length, which is an area for temporarily recording program data that the user is viewing at any time. The long-term saving area 1202 is an area for recording program data that is reserved by the user for video recording or recording program data for a long term when the user performs a control by the recording device control unit 304 for video recording while the user is viewing a program via the monitor 306.

Operations of the recording and reproducing apparatus according to the eighth embodiment of the present invention having the configuration as described above will be hereinafter described with reference to FIGS. 3 and 12. However, features that the eighth embodiment has in common with the sixth embodiment will be omitted and only differences will be described.

First, in viewing by time shift reproduction, it is assumed that program data is set to be recorded with a high image quality.

If the user tries to permanently record a program that the user is viewing by the time shift reproduction, the recording device controlling unit 304 copies program data, which is recorded from the reproduction position 1204 to the recording position 1203 of the temporary saving area 1201, to a predetermined position on the long-term saving area 1202 as high image quality data 1202a and subsequently records a program data of a program that the receiving unit 301 receives for a long term on the long-term saving area 1202 as high image quality data 1202b of the same image quality as image quality with respect to the temporary saving area 1201 in a recording area in the recording device 303.

If an image quality of program data recorded in the temporary saving area 1201 and an image quality desired by a user that is designated by the user are different, an image quality varies in the middle of program data included in an identical program.

In this embodiment, in order not to cause such a state, temporary recording is performed until an end of a program with an image quality temporarily recorded in the temporary saving area 1201, and thereafter the high image quality data 1202a and 1202b, which is a program data portion of a high image quality in the long-term saving area 1202, is converted into image quality data desired by the user 1202c that is a program data portion of a low image quality using the re-encoding unit 309.

In this way, according to this embodiment, since an image quality is not changed while a user is viewing a program even if the user shifts from the time shift reproduction to ordinary recording without causing such a state as to store program data with an image quality varying in the middle in an identical program in data to be recorded in a recording device, incongruity can be eliminated.

Further, although the temporary saving area 1201 is an area in which a user temporarily stores program data that the user is viewing at any time in the description of the eighth embodiment, this embodiment can also be implemented in the same manner if an image quality with which images are temporarily recorded in the temporary saving area 1201 is a highest image quality among image qualities that can be set.

In addition, although program data from the reproduction position 1204 to the recording position 1203 of the temporary saving area 1201 is copied to the long-term saving area 1202 in the eighth embodiment, this embodiment can also be implemented in the same manner if program data is copied from the starting position or an arbitrary position of the temporary saving area 1201.

In addition, although this embodiment is described as an addition of the input unit 307, the image quality control unit 308 and the re-encoding unit 309 to the configuration of the first embodiment, this embodiment may be implemented in the configuration of the second embodiment and can also be implemented in the same manner if a program data portion is reset in a long-term saving area from a starting position or an arbitrary position of a temporary saving area.

In addition, although a conversion of an image quality is performed after recording of program data ends in the description of the above-mentioned embodiment, this embodiment can also be implemented if conversion of an image quality is automatically performed when record processing is not performed after the program ends.

In addition, although conversion of an image quality is performed in the re-encoding unit 309 in the eighth embodiment, this embodiment can also be implemented if program data shown by a chain line in the drawing is circulated and re-encoding of the program data is executed using the decoder 305 and the encoder 302.

Further, in the above-mentioned descriptions, the recording devices 103, 203 and 303 include the temporary saving area and the long-term saving area of the present invention and the recording devices 103, 203 and 303 and the recording device control units 104, 204 and 304 are equivalent to the record reproducing means of the present invention. In addition, the image quality control unit 308, the re-encoding unit 309 or the encoder 302 and the decoder 305 are equivalent to the image quality changing means of the present invention and the display control unit 209 is equivalent to the notifying means of the present invention.

Therefore, the configuration of the present invention is not limited to any of the above-mentioned embodiments and, for example, all or a part of the receiving units 101, 201 and 301 and the encoders 102, 202 and 302, the decoders 105, 205, 305 and the monitors 106, 206 and 306 ma be configured separately. For example, if the present invention is configured with the encoders and the decoders omitted, it becomes possible to use the present invention with respect to a television broadcast by an analog wave as program data. Moreover, if the present invention is configured with only the encoders 102, 202 and 302 omitted, it becomes possible to use the present invention with respect to a digital broadcast for broadcasting an MPEG stream.

In addition, although it is described that an EPG is used for identifying a program and detecting an ending time of a program in the above-mentioned embodiments, the present invention is not limited to this but may be provided with a timer or, if program data is an MPEG stream, detect information included in a header of a stream packet to use it. In short, the present invention may user anything as long as it can perform identification of a program or detection of an ending time of a program.

In addition, although program data is described as consisting of video and voice data in the above-mentioned embodiments, the program data of the present invention may be video data only or may be music data only. In addition, the program data of the present invention may be digitized data or analog data. As digitized data, the program data may be compressed data by the MPEG or digital data of other standard such as DV.

In addition, although the recording devices 103, 203 and 303 are described as being realized by a hard disc drive in the above-mentioned embodiments, the record reproduction apparatus of the present invention may be anything as long as it can set a temporary saving area and a long-term saving area and may be realized as solid memory, a magneto-optical disc drive such as an MO and an optical disc drive such as a DVD-RAM and a CD-RW.

As described above, according to the present invention, as an example, a recording and reproducing apparatus for receiving program data such as videos and voices, recording and reproducing the program data has a temporary saving area for temporarily recording program data that a user is viewing and a long-term saving area for recording program data desired by the user for a long term, which are a ring buffer of a fixed length, in a recording device for recording program data, if the user instructs a long-term recording of program data when time shift reproduction of the program data is performed in the temporary saving area, the program data in the temporary saving area is copied to the long-term saving area whereby an advantageous effect can be realized in that the long-term recording of the program data can be performed.

In addition, according to the present invention, as an example, program data to be copied from a temporary saving area to a long-term saving area is all or a part of program data in the temporary saving area and, if it is a part of the program data in the temporary saving area, it starts from an arbitrary position, whereby an advantageous effect can be realized in that a user can record program data that the user is viewing from an arbitrary position.

In addition, according to the present invention, as an example, if a user instructs long-term recording of a program when time shift reproduction of the program data is performed in the temporary saving area, timing for starting the long-term recording of the program data in the long-term saving area and copying the program data from the temporary saving area to the long-term saving area is executed after performing the long-term recording in the long-term saving area until the end of the program, whereby an advantageous effect can be realized in that copying can be performed smoothly.

In addition, according to the present invention, as an example, if a user instruct long-term recording of a program when simultaneous record reproduction of the program data is performed in the temporary saving area, timing for continuously recording the program data in the temporary saving area and copying the program data from the temporary saving area to the long-term saving area is executed after performing a temporary recording in the temporary saving area until the end of the program, whereby an advantageous effect can be realized in that it is easy to manage files.

In addition, according to the present invention, as an example, a recording and reproducing apparatus for receiving program data such as videos and voices, recording and reproducing the program data has a temporary saving area for temporarily recording program data that a user is viewing and a long-term saving area for recording program data desired by the user for a long term in a recording device for recording program data, and, if the user instructs a long-term recording of program data when simultaneous record reproduction of the program data is performed in the temporary saving area, the program data portion in the temporary saving area is changed to the long-term saving area, whereby an advantageous effect can be realized in that the long-term recording of the program data can be performed.

In addition, according to the present invention, as an example, what is changed from a temporary saving area to a long-term saving area is all or a part of the temporary saving area and, if it is a part of the temporary saving area, it starts from an arbitrary position, whereby an advantageous effect can be realized in that a user can record program data that the user is viewing from an arbitrary position.

In addition, according to the present invention, as an example, a long-term saving area is changed to a temporary saving area by a size of an area that is changed from the temporary saving area to the long-term saving area, whereby an advantageous effect can be realized in that the temporary saving area does not decrease.

In addition, according to the present invention, as an example, program data is temporarily recorded in the order programs are viewed by the user in a temporary saving area and program data that the user wishes to record is connected to be copied to a long-term saving area from the temporary saving area, whereby an advantageous effect can be realized in that only program data that the user wishes to record can be recorded.

In addition, according to the present invention, when a recording and reproducing apparatus has an input unit for receiving an input operation from a user and, when an ending time of any one of programs temporarily recorded in a temporary saving area, which is a variable length, is detected from an EPG, indicates on a monitor screen that the temporary saving area is to be deleted to inform the user to that effect and determines deletion of program data in the temporary saving area by an input operation of the user, whereby an advantageous effect can be realized in that the user can delete program data whenever the user wishes to delete it.

In addition, according to the present invention, as an example, a plurality of temporary saving file of a variable length exist in a temporary saving area, and one piece of program data is temporarily recorded in one temporary saving file and temporary saving files in a number of programs that a user switched are created, whereby an advantageous effect can be realized in that the user can record only program data that the user wishes to record.

In addition, according to the present invention, as an example, at an ending time of a program detected from an EPG, a temporary saving file of the program is deleted, whereby an advantageous effect can be realized in that only program data that has ended can be deleted.

In addition, according to the present invention, as an example, a recording and reproducing apparatus has an input unit for receiving an input operation from a user and has a function for setting an image quality of program data that is recorded for a long term in the long-term saving area using the input unit, whereby an advantageous effect can be realized in that the user can record images with an image quality designated by the user.

In addition, according to the present invention, as an example, since the function for setting an image quality is a function that is capable of only setting an image quality lower than an image quality temporarily recorded in the temporary saving area, an image quality to be temporarily recorded in the temporary saving area is set at a highest image quality among image qualities that can be set, whereby an advantageous effect can be realized in that the function of setting an image quality can set all image qualities.

In addition, according to the present invention, as an example, a recording and reproducing apparatus has a re-encoding unit for converting an image quality of program data recorded in the recording device and has a function for, if an image quality varies in identical program data, making image qualities of program data uniform to coincide with each other, whereby an advantageous effect can be realized in that an image quality of program data can be made uniform.

In addition, according to the present invention, as an example, a recording and reproducing apparatus has a scene change detecting unit for detecting a change of scenes and has a function for, if a long-term recording of an image quality different from an image quality recorded in the temporary saving area using a function for setting an image quality of program data that is to be recorded for a long term in the long-term saving area using the input unit, changing the image quality to an image quality designated by the user at a change of scenes, whereby an advantageous effect can be realized in that an image quality is converted to an image quality designated by the user without incongruity at a change of scenes while the user is viewing a program.

In addition, according to the present invention, as an example, a recording and reproducing apparatus has a function for, if a long-term recording of an image quality different from an image quality recorded in the temporary saving area using a function for setting an image quality of program data that is to be recorded for a long term in the long-term saving area using the input unit, continuously performing recording with an identical image quality until an end of a program, and converting the image quality to a designated quality by using the re-encoding unit after the program ends, whereby an advantageous effect can be realized in that there is not incongruity because an image quality is not changed to an image quality designated by the user while the user is viewing a program.

In addition, according to the present invention, as an example, if an image quality varies in identical program data recorded in the recording device, a function for making image qualities of program data to coincide with each other is automatically operated when a program ends, whereby an advantageous effect can be realized in that conversion of image qualities can be performed smoothly.

In addition, according to the present invention, as an example, if an image quality varies in identical program data recorded in the recording device, a function for making image qualities of program data to coincide with each other is automatically operated when recording processing is not performed after a program ends, whereby an advantageous effect can be realized in that image quality conversion can be performed smoothly.

Furthermore, the present invention is a program for making a computer execute all or part of the functions of the present invention of record reproducing apparatus, the program operating in collaboration with a computer.

Also, the other aspect of the embodiment in use of the program of the present invention may be a mode of being transmitted in transmission media, being read by a computer and of operating in collaboration with the computer.

One part of means (or unit or areas) in this invention means some steps in plural ones or one part of operations in a means.

Also, one part of means (or unit or areas) according to this invention means some devices in plural ones, one part of means (or units or areas ) in a device, or one part of functions in one part of means.

Furthermore, a computer-readable recording medium, in which programs according to this invention are stored, is included in this invention.

As one implementation of programs according to this invention, the programs may be stored in a computer-readable recording medium and perform in cooperation with the computer.

Also, the recording media include ROM or the like, and the transmission media includes transmission mechanism such as optical fiber or Internet, and further light/radio waves and acoustic waves or the like.

Also, the computer of the present invention referred above is not limited pure hardware such as CPU or the like, and it may include firmware, operating system, I/O devices and peripheral devices. Also, as explained above, the constitution of the present invention can be realized by software with easily computer or by hardware of electric circuit, logical circuit or the like.

As apparent from the above description, according to the present invention, a recording and reproducing apparatus that is capable of recording program data that a user is viewing without failure even in the case in which an ordinary recording operation is performed from time shift reproduction.

What is claimed is:

1. A recording and reproducing apparatus for receiving program data including video data and/or voice data and recording and/or reproducing said program data, comprising:
a temporary saving area that is a ring buffer of temporarily recording said program data;
a long-term saving area of recording said program data for a long term; and
record reproducing means of at least performing recording, reproduction or time shift reproduction of said program data in said temporary saving area and/or said long-term saving area,
wherein said record reproducing means copies predetermined program data recorded at least in said temporary saving area to said long-term saving area if said record reproducing means is instructed to record said program data for a long term when it is performing in said temporary saving area the time shift reproduction of program data that is being received.

2. The recording and reproducing apparatus according to claim 1,
wherein said record reproducing means copies program data after temporarily recording said program data in said temporary saving area until the program of said program data that is being received ends.

3. A recording and reproducing apparatus for receiving program data including video data and/or voice data and recording and/or reproducing said program data, comprising:
a temporary saving area that is a ring buffer of temporarily recording said program data;
a long-term saving area of recording said program data for a long term; and
record reproducing means of at least performing recording, reproduction or time shift reproduction of said program data in said temporary saving area and/or said long-term saving area,
wherein said record reproducing means copies predetermined program data recorded in said temporary saving area to said long-term saving area and at the same time records program data that is being received other than that copied in said long-term saving area in said long-term saving area if said record reproducing means is instructed to record said program data for a long term when it is performing the time shift reproduction of said program data that is being received in said temporary saving area.

4. The recording and reproducing apparatus according to claim 3,
wherein timing at which said record reproducing means copies said program data from said temporary saving area to said long-term saving area is performed immediately after said record reproducing means is instructed to record said program data for a long time.

5. The recording and reproducing apparatus according to claim 3,
wherein timing at which said record reproducing means copies said program data from said temporary saving area to said long-term saving area is performed immediately before said temporary saving area is overwritten and recorded.

6. The recording and reproducing apparatus according to claim 3,
wherein said record reproducing means records said program data that is being received in said long-term saving area after stopping at least a recording operation with respect to said temporary saving area.

7. The recording and reproducing apparatus according to claim 3,
wherein said predetermined program data to be copied from said temporary saving area to said long-term saving area is all or a part of program data recorded in said temporary saving area and, in case of said part of said recorded program data, said predetermined program data is data recorded in an arbitrary area on said temporary saving area.

8. A recording and reproducing apparatus for receiving program data including video data and/or voice data and recording and/or reproducing said program data, comprising:
a recording area in which a temporary saving area of temporarily recording said program data and a long-term saving area of recording said program data for a long term can be set; and
record reproducing means for setting said temporary saving area and said long-term saving area on said recording area and performs at least recording, reproduction or time shift reproduction of said program data in said temporary saving area or said long-term saving area,
wherein said record reproducing means resets a predetermined portion in which said program data from a reproduction position address to a recording position address at the time of said time shift reproduction on said temporary saving area as said long-term saving area if said record reproducing means is instructed to record said program data for a long term when it is performing in said temporary saving area the time shift reproduction of program data that is being received.

9. The recording and reproducing apparatus according to claim 8,
wherein said predetermined portion to be treated as said long-term saving area, in which said program data is recorded on said temporary saving area, is all or a part of said temporary saving area and, in case of said part of said temporary saving area, said predetermined portion is data recorded in an arbitrary area on said temporary saving area.

10. The recording and reproducing apparatus according to claim 8,
wherein an area of a size identical with a long-term saving area obtained by said resetting on said long-term saving area is reset as said temporary saving area.

11. The recording and reproducing apparatus according to any one of claims 1, 3 and 8,
wherein said program data is temporarily recorded in the order of receipt in said temporary saving area, and
said program data is temporarily recorded such that said program data can be identified from each other for each channel and/or each program on said temporary saving area.

12. The recording and reproducing apparatus according to claim 11,
wherein said record reproducing means connects predetermined portions among said program data temporarily recorded in said temporary saving area based on an input from a user and copies the connected portions to said long-term saving area.

13. The recording and reproducing apparatus according to claim 11,
wherein said program data with said predetermined portions connected belongs to one program.

14. The recording and reproducing apparatus according to claim 11,
wherein identification of said program data is defined by an EPG (Electronic Program Guide).

15. The recording and reproducing apparatus according to any one of claims 1, 3 and 8,
wherein said record reproducing means deletes program data recorded in said temporary saving area if any program of program data temporarily recorded in said temporary saving area ends.

16. The recording and reproducing apparatus according to claim 15,
wherein said any program is a program that a user is currently being viewed by a user.

17. The recording and reproducing apparatus according to claim 15, further comprising notifying means of notifying a user of operating contents of said recording and reproducing apparatus,
wherein said notifying means notifies the user that program data recorded in said temporary saving area is to be deleted.

18. The recording and reproducing apparatus according to claim 15, further comprising an input unit for receiving an input operation from a user,
wherein program data in said temporary saving area is deleted by the input operation of the user via said input unit.

19. The recording and reproducing apparatus according to claim 15,
wherein a time when said program ends is defined by an EPG (Electronic Program Guide).

20. The recording and reproducing apparatus according to any one of claims 1, 3 and 8,
wherein said temporary saving area has a plurality of temporary saving files.

21. The recording and reproducing apparatus according to claim 20,
wherein said program data of one program is temporarily recorded in one of said temporary saving files.

22. The recording and reproducing apparatus according to claim 20 or 21,
wherein said temporary saving file has temporary saving files in a number of programs that a user has viewed.

23. The recording and reproducing apparatus according to claim 21,
wherein said program is defined by an EPG (Electronic Program Guide).

24. The recording and reproducing apparatus according to any one of claims 1, 3 and 8, further comprising image quality changing means of changing an image quality of program data to be recorded in said temporary saving area and/or said long-term saving area.

25. The recording and reproducing apparatus according to claim 24,
wherein change of an image quality of program data to be recorded in said long-term saving area is for making the image quality equal to or lower than an image quality of program data temporarily recorded in said temporary saving area.

26. The recording and reproducing apparatus according to claim 25,
wherein an image quality of said program data to be temporarily recorded in said temporary saving area is set at the highest.

27. The recording and reproducing apparatus according to claim 24,
wherein said image quality changing means makes all image qualities of program data of an identical program to coincide with each other if an image quality varies in said program data of said identical program.

28. The recording and reproducing apparatus according to claim 27,
wherein an operation for making all the image qualities of said program data of said identical program is automatically performed when said program ends.

29. The recording and reproducing apparatus according to claim 27,
wherein an operation for making all the image qualities of said program data of said identical program is automatically performed when said record reproducing means is not performing a recording operation after said program ends.

30. The recording and reproducing apparatus according to claim 24,
wherein said record reproducing means records program data for a long term with an image quality identical with that of program data saved in said temporary saving area until a program ends and said image quality changing means converts an image quality of program data recorded in said long-term saving area to an image quality designated by a user after said program ends if an image quality different from an image quality of program data recorded in said temporary saving area is designated in said image quality changing means in recording program data for a long time in said long-term saving area.

31. The recording and reproducing apparatus according to any one of claims 28 to 30,
wherein the end of said program is defined based on an EPG (Electronic Program Guide).

32. The recording and reproducing apparatus according to claim 24, further comprising a scene change detecting unit for detecting a change of scenes in program data of identical programs or programs different from each other,
wherein said image quality changing means has a function for, if a long-term recording of an image quality different from an image quality recorded in said temporary saving area is designated, changing an image quality to an image quality designated by the user based on said change of scenes detected by said scene change detecting unit.

33. The recording and reproducing apparatus according to claim 1 or 8,
wherein said ring buffer of said temporary saving area has a variable length.

34. The recording and reproducing apparatus according to claim 3 or 8,
wherein said ring buffer of said temporary saving area has a fixed length.

35. A recording and reproducing method for receiving program data including video data and/or voice data and recording and/or reproducing said program data, comprising:
a step of using a temporary saving area that is a ring buffer of temporarily recording said program data and a long-term saving area of recording said program data for a long term; and
a record reproducing step of at least performing recording, reproduction or time shift reproduction of said program data in said temporary saving area and/or said long-term saving area,
wherein by said record reproducing step predetermined program data recorded at least in said temporary saving area is copied to said long-term saving area if in said record reproducing step it is instructed to record said program data for a long term when the time shift reproduction of program data that is being received in said temporary saving area is performed.

36. A recording and reproducing method for receiving program data including video data and/or voice data and recording and/or reproducing said program data, comprising:
a step of using a temporary saving area that is a ring buffer of temporarily recording said program data and a long-term saving area of recording said program data for a long term; and
a record reproducing step of at least performing recording, reproduction or time shift reproduction of said program data in said temporary saving area and/or said long-term saving area,
wherein by record reproducing means predetermined program data recorded in said temporary saving area is copied to said long-term saving area and at the same time program data that is being received other than that copied in said long-term saving area in said long-term saving area is recorded if in said record reproducing means it is instructed to record said program data for a long term when the time shift reproduction of said program data that is being received in said temporary saving area is performed.

37. A recording and reproducing method for receiving program data including video data and/or voice data and recording and/or reproducing said program data, comprising:
a step of using a recording area in which a temporary saving area of temporarily recording said program data and a long-term saving area for recording said program data of a long term can be set; and
a record reproducing step of setting said temporary saving area and said long-term saving area on said recording area and performs at least recording, reproduction or time shift reproduction of said program data in said temporary saving area or said long-term saving area,
wherein by said record reproducing means a predetermined portion in which said program data from a reproduction position address to a recording position address is reset at the time of said time shift reproduction on said temporary saving area as said long-term saving area if in said record reproducing step it is instructed to record said program data for a long term when the time shift reproduction of program data that is being received in said temporary saving area is performed.

38. A program for causing a computer to function as all or any of the record reproducing means of at least performing recording, reproduction or time shift reproduction of said program data in said temporary saving area and/or said long-term saving area of the recording and reproducing apparatus according to claim 1.

39. A program for causing a computer to function as all or any of the record reproducing means of at least performing recording, reproduction or time shift reproduction of said program data in said temporary saving area and/or said long-term saving area of the recording and reproducing apparatus according to claim 3.

40. A program for causing a computer to function as all or any of the record reproducing means of setting said temporary saving area and said long-term saving area on said recording area and performs at least recording, reproduction or time shift reproduction of said program data in said temporary saving area or said long-term saving area of the recording and reproducing apparatus according to claim 8.

41. A medium to store programs for causing a computer to function as all or any of the record reproducing means of at least performing recording, reproduction or time shift reproduction of said program data in said temporary saving area and/or said long-term saving area of the recording and reproducing apparatus according to claim 1, wherein said medium is enable to be processed by said computer.

42. A medium to store programs for causing a computer to function as all or any of the record reproducing means of at least performing recording, reproduction or time shift reproduction of said program data in said temporary saving area and/or said long-term saving area of the recording and reproducing apparatus according to claim 3, wherein said medium is enable to be processed by said computer.

43. A medium to store programs for causing a computer to function as all or any of the record reproducing means of setting said temporary saving area and said long-term saving area on said recording area and performs at least recording, reproduction or time shift reproduction of said program data in said temporary saving area or said long-term saving area of the recording and reproducing apparatus according to claim 8, wherein said medium is enable to be processed by said computer.
